(19) United States
(12) Patent Application Publication
(10) Pub. No.: US 2003/0074784 A1
(43) Pub. Date: Apr. 24, 2003

(54) Method of forming protective film on magnetic head

(76) Inventors: Yoshiyuki Konishi, Hatano-shi (JP); Dai Kitahara, Hatano-shi (JP)

Correspondence Address: KANESAKA AND TAKEUCHI, 1423 Powhatan Street, Alexandria, VA, 22314, US

(21) Appl. No.: 10/305,242

(22) Filed: Nov. 27, 2002

Related U.S. Application Data
(62) Division of application No. 09/686,871, filed on Oct. 12, 2000.

(30) Foreign Application Priority Data
Oct. 29, 1999 (JP) 11-310166

(51) Int. Cl. H04R 31/00; G11B 5/187; G11B 5/127

(52) U.S. Cl. 29/603.07; 360/122

(57) ABSTRACT

A protective film is formed on a magnetic head for recording and reading data in a magnetic recording medium. The method includes the steps of forming a corrosion-resistant film on an entire surface of the magnetic head, and forming a wear-resistant film on the corrosion-resistant film without exposing the corrosion-resistant film to atmosphere. The wear-resistant film has a wear resistance greater than that of the corrosion-resistant film.

### CROSS-REFERENCE TO RELATED APPLICATION

This is a divisional application of Ser. No. 09/686,871 filed on Oct. 12, 2000.

### BACKGROUND OF THE INVENTION AND RELATED ART STATEMENT

The present invention relates to a method of forming protective film formed on a magnetic head of a magnetic recording device.

In a magnetic recording device, recording and/or reproducing data with respect to a magnetic recording medium is carried out by using a magnetic head. For example, in an HD magnetic recording device which records data in a magnetic disc, there is generally used a CCS (Contact Start and Stop) mechanism, which allows the magnetic head to float for a predetermined distance from a disc surface in recording and reproducing data (access time), and which allows the magnetic head to be located on the disc surface at a non-access time. Therefore, a protective film for protecting the surface is formed on a surface of the magnetic head facing the disc, that is, the surface through which recording and reproducing is carried out. As the protective film as described above, a DLC (Diamondlike Carbon) film, which is formed by ECR (electron cyclotron resonance)—CVD (chemical vapor deposition) method or by Ion Beam Deposition method, or a carbon film, which is formed by Sputter Carbon method or FCVA (Filtered Cathodic Vacuum Arc) method, is used.

Since the magnetic head contacts the disc surface during the non-access time as described above, the protective film of the magnetic head is required to have a wear resistance as well as a corrosion resistance. Therefore, after a thin film for corrosion resistance (hereinafter referred to as a corrosion-resistant film) is formed on a base plate of the head, a thin film for wear resistance (hereinafter referred to as a contact film) is formed on the corrosion-resistant film. The contact film is also called as a pad, and a plurality of the contact films in an island shape is formed on the corrosion-resistant film. When the magnetic head is landed on the disc, only the contact film contacts the disc. Conventionally, both the corrosion-resistant film and the contact film are formed of the same kind of films formed by the same film forming method, for example, the DLC films formed by the ECR-CVD method.

However, none of the respective films formed by the respective film forming methods have both the corrosion resistance and the wear resistance. For example, the DLC film formed by the ECR-CVD method is excellent in the corrosion resistance, but is poor in the wear resistance. On the contrary, a ta-C (tetrahedral amorphous carbon) film formed by the FCVA method has a very high hardness and excellent wear resistance, but is poor in the corrosion resistance. Namely, there is a problem in the wear resistance when the corrosion-resistant film and the contact film are formed of the DLC films, and there is a problem in the corrosion resistance when the corrosion-resistant film and the contact film are formed of the ta-C films.

Accordingly, an object of the present invention is to provide a method of forming a protective film which is excellent in both corrosion resistance and the wear resistance.

Further objects and advantages of the invention will be apparent from the following description of the invention.

### SUMMARY OF THE INVENTION

To achieve the aforementioned object, according to a first aspect of the invention, the present invention provides a protective film formed on a magnetic head for recording and/or reproducing data with respect to a magnetic recording medium, wherein the protective film is formed of a corrosion-resistant film formed to cover a base plate surface of the head, and a wear-resistant film formed on the corrosion-resistant film. The wear-resistant film contacts the magnetic recording medium, and has an wear resistance higher than that of the corrosion-resistant film.

According to a second aspect of the invention, in the protective film described above, the corrosion-resistant film is formed of a DLC (Diamondlike Carbon) film formed by an ECR-CVD method, and the wear-resistant film is formed of a ta-C (tetrahedral amorphous carbon) film formed by FCVA (Filtered Cathodic Vacuum Arc) method.

According to a third aspect of the invention, in the protective film described above, Si (silicon) films are respectively provided between the base plate,surface of the head and the DLC film, and between the DLC film and the ta-C film.

A compound film forming apparatus according to a fourth aspect of the invention is formed of a plurality of film forming devices for forming films on a base plate, and a transferring device communicating with the respective film forming devices through opening and closing means to thereby transfer the base plate to the respective film forming devices.

According to a fifth aspect of the invention, in the compound film forming apparatus described above, a plurality of the film forming devices has the same base plate holding mechanism, respectively.

According to a sixth aspect of the invention, in the compound film forming apparatus described above, the film forming devices include an ECR-CVD film forming device for forming the DLC film, and an FCVA film forming device for forming the ta-C film.

According to a seventh aspect of the invention, a method of forming the protective film comprises the steps of placing the magnetic head in a load lock chamber; evacuating the load lock chamber; transferring the magnetic head to a corrosion-resistant film forming device (ECR-CVD device) in a vacuum state; forming a corrosion-resistant film on a base plate surface of the head in the corrosion-resistant film forming device; transferring the magnetic head to a wear-resistant film forming device (FCVA device) in a vacuum state; and forming a wear-resistant film on the corrosion-resistant film in the wear-resistant film forming device.

### BRIEF DESCRIPTION OF THE DRAWINGS

FIGS. 1(a) through 1(c) are views for showing an example of a magnetic recording device to which a protective film according to the present invention is applied, wherein FIG. 1(a) is a perspective view for showing a part of a magnetic disc device; FIG. 1(b) is a view seen from an arrow A in FIG. 1(a), showing a condition that a magnetic head is floated from a disc; and FIG. 1(c) is a view seen from the arrow A in FIG. 1(a), showing a condition that the magnetic head is landed on the disc;

FIG. 2 is a schematic view showing a section of the magnetic head;

FIG. 3 is a schematic view of a compound film forming apparatus according to the present invention;

FIG. 4 is a block diagram schematically showing a structure of an ECR-CVD device;

FIG. 5 is a schematic view for explaining an FCVA device;

FIGS. 6(a) through 6(c) are sectional views of a magnetic sensor respectively showing steps of forming films;

FIGS. 7(a) and 7(b) are sectional views of the magnetic sensor respectively showing steps of forming films continuing from the step shown in FIG. 6(c);

FIG. 8 is a block diagram showing another example of the ECR-CVD device;

FIG. 9 is a perspective view of a base plate adapter;

FIG. 10 is a view showing a base plate holder loaded in a reaction chamber;

FIG. 11 is an explanatory view for explaining an attachment of the base plate adapter to a hanging jig by a transfer robot; and

FIG. 12 is a sectional view showing a modified example of the protective film.

### DETAILED DESCRIPTION OF PREFERRED EMBODIMENTS

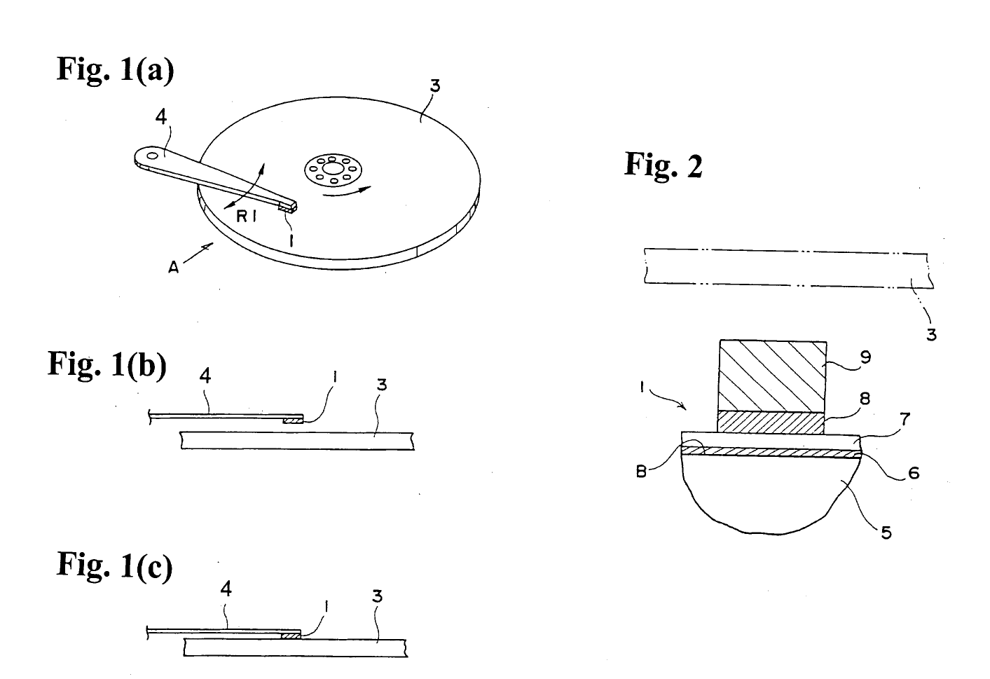

Hereunder, embodiments of the invention will be explained with reference to FIG. 1(a) through FIG. 12. FIGS. 1(a) through 1(c) are views for showing an example of a magnetic recording device to which a protective film according to the present invention is applied, wherein FIG. 1(a) is a perspective view for showing a part of a magnetic disc device; FIG. 1(b) is a view seen from an arrow A in FIG. 1(a), showing a condition that a magnetic head is floated from a disc; and FIG. 1(c) is a view seen from the arrow A in FIG. 1(a), showing a condition that the magnetic head is landed on the disc.

A magnetic head 1 is attached to a distal end of an arm 4, and by swinging the arm 4 as shown by an arrow R1 in the figure, the magnetic head 1 can be smoothly moved at any positions on a magnetic disc 3 which is rotating. In case recording or reproducing data is carried out with respect to the magnetic disc 3, the magnetic head 1 is floated as shown in FIG. 1(b). In the case other than recording or reproducing the data, the magnetic head 1 is landed on the magnetic disc 3 as shown in FIG. 1(c).

Next, a protective film is explained. FIG. 2 schematically shows a section of the magnetic head in a condition that the magnetic head 1 is floated (refer to FIG. 1(b)), wherein a recording surface of the magnetic disc 3 is located at an upper side in the figure. An Si (silicon) film 6 is formed on a surface B of a magnetic sensor 5 of the magnetic head 1, and a DLC film 7 for corrosion resistance is formed on the Si film 6 by an ECR-CVD method. Further, a ta-C film 9 is formed on the DLC film 7 through an Si film 8. The ta-C film 9 is called a pad, and formed in an island shape, i.e. like spots, on the DLC film 7 formed on a surface B in its entirety. When the magnetic head 1 is landed on or contacts a disc surface, only the ta-C film 9 contacts a disc surface, and between the DLC film 7 and the disc surface, there is formed a gap corresponding to a sum of a film thickness of the Si film 8 and a film thickness of the ta-C film 9. Namely, a protective film of this embodiment is formed of the ta-C film 9, which functions as a contact film, and the DLC film 7, which functions as a corrosion-resistant film, and the protective film is structured such that only the contact film contacts the disc surface.

As described above, the DLC film 7 formed by the ECR-CVD method is excellent in the corrosion resistance, but is poor in the wear resistance. However, in the magnetic head 1 shown in FIG. 2, since the DLC film 7 does not contact the disc surface when the magnetic head 1 is landed on the magnetic disc 3, no damage is caused in the DLC film 7 due to the contact, and at the same time, the corrosion resistance is maintained. On the other hand, the ta-C film 9 as the contact film has a very high hardness and is excellent in the wear resistance, so that the ta-C film 9 can sufficiently fulfill the function as the contact film. Namely, the protective film of the embodiment of the invention has both the corrosion resistance and the wear resistance, and is optimal as a protective film of the magnetic head 1. Incidentally, in the protective film shown in FIG. 2, the thicknesses of the Si film 6, the DLC film 7, the Si film 8, and ta-C film 9 are ranged from several nm to several tens nm.

Incidentally, although the Si film 6 and the Si film 8 are respectively provided for improving an adhesiveness between the surface B and the DLC film 7, and an adhesiveness between the DLC film 7 and the ta-C film 9, the Si films 6 and 8 can be omitted such that the DLC film 7 and the ta-C film 9 are directly formed.

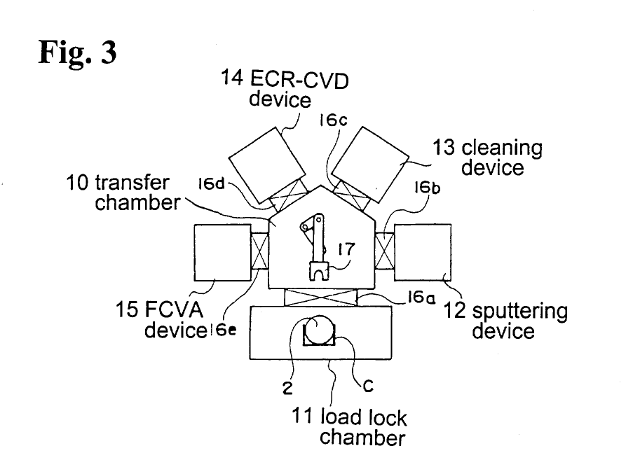

FIG. 3 is a view showing a schematic structure of a compound film forming apparatus for forming the protective films described above. In this compound film forming apparatus, a load lock chamber 11, a sputtering device 12, a cleaning device 13, an ECR-CVD device 14, and an FCVA device 15 are formed integrally with a transfer chamber 10 having a transferring robot 17 through gate valves 16a, 16b, 16c, 16d, and 16e. The Si films 6 and 8 are formed in the sputtering device 12; the DLC film 7 is formed in the ECR-CVD device 14; and the ta-C film 9 is formed in the FCVA device 15. Also, in the cleaning device 13, foreign materials (oxide film or the like) on the surface B of the magnetic sensor 5 can be removed by etching and so on.

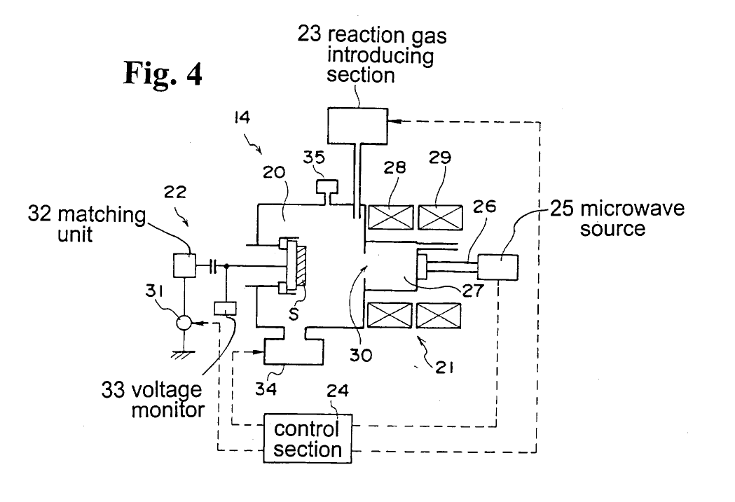

Here, the ECR-CVD device 14 for forming the DLC film 7 and the FCVA device 15 for forming the ta-C film 9 will be explained. FIG. 4 is a block diagram for showing a schematic structure of the ECR-CVD device 14. The ECR-CVD device 14 includes a reaction chamber 20 for forming a thin film on a sample S (magnetic sensor 5 in the embodiment) disposed therein; an ECR plasma generating section 21 for introducing a plasma flow into the reaction chamber 20; a bias electric supply section 22 for applying a bias voltage to the sample S; a reaction gas introducing section 23 for introducing a reaction gas into the reaction chamber 20; and a control section 24 for controlling an entire device and film forming conditions.

The ECR plasma generating section 21 has a mechanism which generates an electron cyclotron resonance (ECR) plasma by supplying a microwave electric power in a magnetic field, to thereby introduce a plasma flow into the reaction chamber 20. Microwave of 2.45 GHz generated in a microwave source 25 is introduced into a plasma chamber 27 through a waveguide 26 to generate a microwave discharge. Further, a magnetic flux density of 875 G in an ECR condition is formed by a magnetic field by coils 28 and 29 to thereby generate an electron cyclotron resonance, so that an active ECR plasma is generated. The ECR plasma generated in the plasma chamber 27 is moved from a plasma window 30 to a side of the sample S in the reaction chamber 20 along the diverging magnetic field.

In the bias electric supply section 22, a bias electric supply 31 is connected to a sample holding mechanism in the reaction chamber 20 through a matching unit 32, and a negative bias voltage is applied to the sample S disposed in the reaction chamber 20. The bias voltage is measured by a voltage monitor 33. The reaction gas introduced from the reaction gas introducing section 23 to the reaction chamber 20 is ionized in a high density plasma by the ECR, and a film is formed on the sample S by the negative bias voltage. In case of forming the DLC film, ethylene (C₂H₄), methane (CH₄), propane (C₃H₈) or the like is supplied as a film forming gas from the reaction gas introducing section 23. Numeral 34 designates an exhaust pump for exhausting air from the reaction chamber 20, and numeral 35 designates a manometer which measures a pressure in the reaction chamber 20.

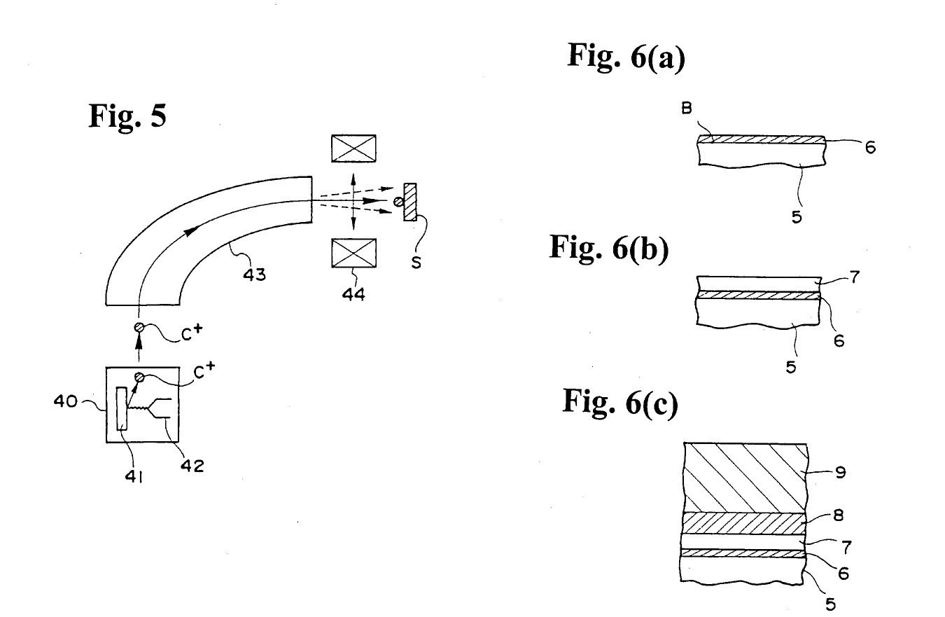

FIG. 5 is a schematic view for explaining the FCVA device 15. Numeral 40 designates a carbon ion generating source, in which carbon ions C⁺ are generated by a vacuum arc discharge between a cathode 41 and an anode 42. The cathode 41 is formed of a high purity graphite in a disc shape. The carbon ions C⁺ generated in the carbon ion generating source 40 form a film on the sample S after passing through a filter 43. The filter 43 allows only the necessary carbon ions to pass therethrough by utilizing an electric field and the magnetic field, and unnecessary large carbon particles or neutral carbon atoms are removed by the filter 43.

A magnetic coil 44 is disposed in the vicinity of an outlet of the filter 43, and the carbon ion beam is scanned by the magnetic coil 44 so that the ta-C film formed on the sample S becomes uniform. Incidentally, the bias voltage may be applied to the sample S. An energy of the ion reaching the sample S depends on the bias voltage, and film characteristics can be changed by the bias voltage.

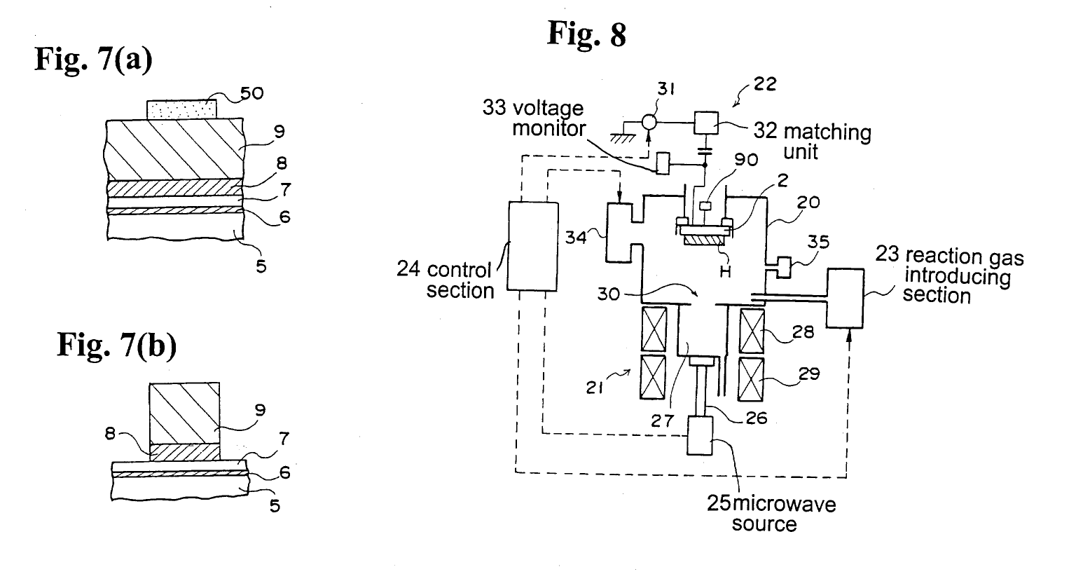

Next, procedures for manufacturing the protective films will be explained with reference to FIG. 3 and FIGS. 6(a) through 7(b). FIGS. 6(a) through 7(b) are sectional views showing steps of forming the protective film, and the steps proceed in the order of FIGS. 6(a), 6(b), 6(c), 7(a) and 7(b). Firstly, the load lock chamber 11 is opened to atmosphere and a base plate cassette C in which a plurality of the magnetic sensors 5 is stored is loaded or placed in the load lock chamber 11. At this point, the gate valves 16b, 16c, 16d, and 16e are closed, and the transfer chamber 10, the sputtering device 12, the cleaning device 13, the ECR-CVD device 14, and the FCVA device 15 are respectively evacuated, that is, in vacuum states.

Next, after the load lock chamber 11 is evacuated, the gate valve 16ais opened, and the magnetic sensor 5 is transferred by the transferring robot 17 from the load lock chamber 11 to the transfer chamber 10. Then, after the gate valve 16ais closed, the gate valve 16c is opened so that the magnetic sensor 5 is transferred to the cleaning chamber 13. Then, the gate valve 16c is closed, and the surface B of the magnetic sensor 5 is cleaned by etching. When the cleaning is finished, the gate valve 16c is opened so that the magnetic sensor 5 is taken out from the cleaning chamber 13. After the gate valve 16c is closed, the gate valve 16b is opened, and the magnetic sensor 5 is transferred to the sputtering device 12. Thereafter, the gate valve 16b is closed, and the Si film 6 is formed on the entire surface B of the magnetic sensor 5 by sputtering (refer to FIG. 6(a)).

When the formation of the Si film 6 is finished, the gate valve 16b is opened, and the magnetic sensor 5 is taken out. Then, after the gate valve 16b is closed, the gate valve 16d is opened, and the magnetic sensor 5 is transferred to the ECR-CVD device 14. Thereafter, the gate valve 16d is closed, and the DLC film 7 is formed on the Si film 6 by the ECR-CVD method (refer to FIG. 6(b)). When the formation of the DLC film 7 is finished, the gate valve 16d is opened, and the magnetic sensor 5 is taken out from the ECR-CVD device 14. After the gate valve 16d is closed, the gate valve 16b is opened, and the magnetic sensor 5 is again transferred to the sputtering device 12. Then, the gate valve 16b is closed, and the Si film 8 is formed on the DLC film 7 by sputtering.

Thereafter, the gate valve 16b is opened, and the magnetic sensor 5 is taken out from the sputtering device 12. After the gate valve 16b is closed, the gate valve 16e is opened, and the magnetic sensor 5 is transferred to the FCVA device 15. Then, the gate valve 16e is closed, and the ta-C film 9 is formed on the Si film 8 (refer to FIG. 6(c)). When the respective films 6 through 9 are formed on the surface B as described above, the magnetic sensor 5 is taken out from the compound film forming apparatus, and a resist pattern 50 in a rectangular form is formed on the ta-C film 9 (refer to FIG. 7(a)). Then, the Si film 8 and the ta-C film 9 are etched by using the resist pattern 50 as a mask, and when the resist pattern 50 is removed, a pad in an island form, which is formed of the Si film 8 and the ta-C film 9, is formed on the Si film 7 as shown in FIG. 7(b).

When the compound film forming apparatus described above is compared with the conventional film forming apparatus in which the respective film forming processes are carried out by independent and separate film forming apparatuses, since the magnetic sensor 5 is not exposed to air until the sequential film forming steps are completed in the compound film forming apparatus, moisture or dust is prevented from adhering to the magnetic sensor 5, so that the protective film with a high quality can be formed. Also, in case the film formation is carried out by the separate film forming apparatuses, auxiliary exhaust chambers are provided before the film forming chambers in the respective film forming apparatuses. The magnetic sensor 5 is transferred to each auxiliary chamber, and after the auxiliary chamber is evacuated, the magnetic sensor 5 is transferred to each film forming chamber. On the other hand, in the apparatus of the embodiment of the invention, after the magnetic sensor 5 is loaded or placed in the load lock chamber 11 and the load lock chamber 11 is evacuated, there is no evacuation like auxiliary chambers for the film forming process in the conventional apparatus, so that time for forming the protective film can be shortened.

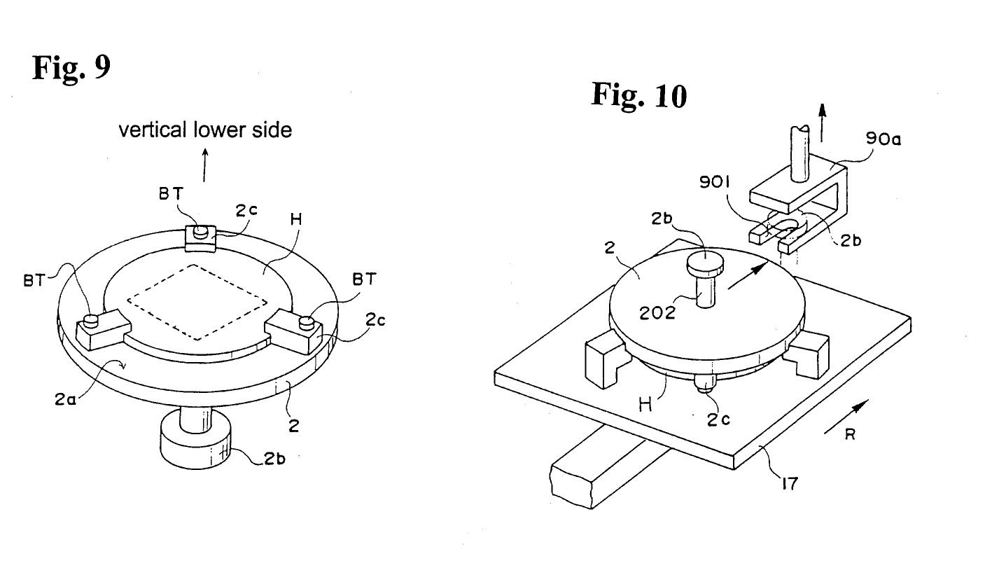

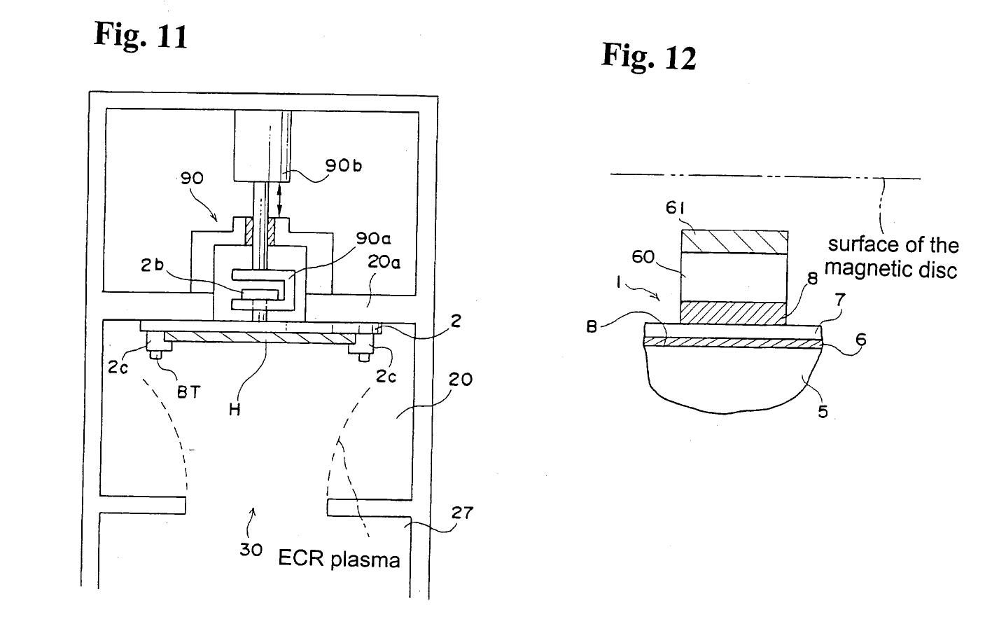

Although the sample S is held in a laterally facing condition in the ECR-CVD device shown in FIG. 4, as in the ECR-CVD device shown in FIG. 8, a base plate holder H (described later), on which the magnetic sensor 5 is loaded, can be held in a downwardly facing condition to form the protective film on the surface B of the magnetic sensor 5. Numeral 2 designates a base plate adapter to which the base plate holder H is fixed, and FIG. 9 and FIG. 10 show the base plate adapter 2 and a chucking mechanism 90 for holding the base plate adapter 2. Since parts other than the base plate adapter 2 and the chucking mechanism 90 are the same as in the apparatus shown in FIG. 4, explanations thereof are omitted.

FIG. 9 is a perspective view of the base plate adapter 2 on which the base plate holder H is mounted. Incidentally, in FIG. 9, an upper side of the figure is shown as a vertical lower side. The magnetic sensor 5 is mounted at a position of the base plate holder H shown by a broken line such that the surface B (refer to FIG. 2) faces outside of the holder H. On a lower surface 2a of the base plate adapter 2, the base plate holder H is fixed by using claws 2c and bolts BT. On an upper surface of the base plate adapter 2 (surface opposite to the surface 2a to which the base plate holder H is mounted), a head section 2b is formed to project outwardly. The adapter 2 in which the base plate holder H is mounted is transferred to the reaction chamber 20 shown in FIG. 8 in the condition that the surface B faces vertically downwardly.

FIG. 10 is a view showing the base plate holder H loaded in the reaction chamber 20, and the base plate adapter 2 in which the base plate holder H is mounted is suspended by engaging the head section 2b of the base plate adapter 2 with a hanging jig 90a of the chucking mechanism 90. As shown in FIG. 10, the transferring robot 17 on which the base plate adapter 2 is placed is moved in a direction of an arrow R in the figure with respect to the hanging jig 90a, and a shaft 202 of the head section 2b is inserted into an elongate hole portion 901 formed in the hanging jig 90a. Then, when the hanging jig 90a is pulled upwardly by an actuator 90b (air cylinder or the like is used) shown in FIG. 11, the head section 2b is engaged with the hanging jig 90a, so that the base plate adapter 2 is suspended by the hanging jig 90a.

When the base plate adapter 2 on which the base plate holder H is mounted is suspended from the hanging jig 90a, the hanging jig 90a is further pulled upwardly by the actuator 90b, so that the upper surface of the base plate adapter 2 abuts against an upper wall 20a of the reaction chamber 20. As described above, the base plate adapter 2 on which the base plate holder H is mounted is fixed in the reaction chamber 20, and thereafter, the film forming process is carried out.

The aforementioned chucking mechanism 90 is not only provided in the ECR-CVD device 14, but also provided in the respective sputtering device 12, cleaning device 13, and FCVA device 15. The base plate holder H on which the magnetic sensor 5 is mounted is fixed to the base plate adaptor 2, and the base plate adaptor 2 is transferred between the respective devices in the condition that the surface B faces downwardly while the respective processes are carried out in the devices in this condition, When the transfer and film formation are carried out in the condition that the surface B faces downwardly, a dust or the like is prevented from adhering to the surface B, so that the protective film with high quality can be formed. Also, since the chucking mechanism 90 is unified in all of the devices, reduction in cost for the apparatus can be achieved.

Also, as shown in FIG. 3, if the base plate cassette C storing a plurality of the base plate holders H mounted in the base plate adapters 2 is loaded in the load lock chamber 11, until the film formation for the plurality of the base plate holders H is completed, the load lock chamber 11 is not opened to the atmosphere, so that time for forming the films can be shortened.

FIG. 12 is a sectional view showing a modified example of the protective film shown in FIG. 2 and is shown in the same condition as in FIG. 2. In the protective film shown in FIG. 12, the DLC film 7, which is the same as in FIG. 2, is used as a corrosion-resistant film. On the other hand, as a contact film, a ta-C film 61 formed on a front surface of a DLC film 60 is used. The DLC film 60 is formed by the ECR-CVD method, and the ta-C film 61 is formed by the FCVA method. Manufacturing procedures until the Si film 8 is formed are the same as the aforementioned procedures. After the DLC film 60 (by the ECR-CVD method) and the ta-C film 61 (by the FCVA method) are formed on the Si film 8 in order, the Si film 8, the DLC film 60 and the ta-C film 61 are etched to form the contact film (pad) as shown in FIG. 12.

Although the ta-C film has a high internal stress and a weak adhesiveness with respect to a substrate or underlayer, as shown in FIG. 12, since almost all of the contact film,is formed of the DLC film 60 and the ta-C film 61 is thinly formed thereon, the problem in the adhesiveness can be reduced. Also, since the ta-C film 61 is very high in the wear resistance, by covering only a front surface of the contact film by the ta-C film 61, a sufficient wear resistance can be attained. Incidentally, as in the example shown in FIG. 2, if an Si film is formed between the ta-C film and the DLC film, the adhesiveness can be further improved. Reversely, the Si films 6 and 8 may be omitted.

In the film forming apparatus shown in FIG. 3, the common transfer chamber 10 is provided with the cleaning device 13 (etching device), which is required for the sequential film forming processes, in addition to the film forming devices, such as the sputtering device 12, the ECR-CVD device 14 and the FCVA device. In the present invention, such a device required for the sequential film forming process is included as the film forming device. Also, although the film-formed surface, i.e. the surface on which the film is formed, faces laterally or downwardly in the devices shown in FIG. 4 and FIG. 8, the orientation of the film-formed surface is not limited to the above, and for example, the film-formed surface can face upwardly.

Although the films 6 and 8 are the Si films in the above embodiments, as an intermediate layer for improving the adhesiveness, an SiC film may be used instead of the Si film. Also, although the protective film of the magnetic head is explained as an example in the embodiment, the present invention may be applied to a protective film for a blade of a cutting tool or other protective films, to thereby improve a corrosion resistance of the blade as well as a wear resistance thereof.

In regard to the parts of the aforementioned embodiments with respect to the elements in the claimed invention, the magnetic disc 3 constitutes the magnetic recording medium; the surface B constitutes the base plate surface of the head; the DLC film 7 constitutes the corrosion-resistant film; the ta-C film 9 or 61 constitutes the wear-resistant film; the base plate adapter 2 or the chucking mechanism 90 constitutes a base plate holding mechanism; the gate valves 16b, 16d, 16e constitute opening and closing means; and the transfer chamber 10 constitutes a transferring device.

As described above, according to the first, second and third aspects of the invention, a corrosion of the magnetic head is prevented by the corrosion-resistant film formed to cover the base plate surface of the head, and the wear-resistant film which is more excellent in the wear resistance than the corrosion-resistant film is formed on the corrosion-resistant film to thereby constitute the protective film. Accordingly, the protective film having both the corrosion resistance and the wear resistance can be formed.

According to the fourth aspect of the invention, since there is no need for evacuation from the atmospheric pressure at each film forming process as in the conventional apparatus, time required for forming the protective film can be shortened.

According to the fifth aspect of the invention, since the base plate holding mechanisms in the respective film forming devices which form the compound film forming apparatus are unified, reduction in cost for the apparatus can be achieved.

While the invention has been explained with reference to the specific embodiments of the invention, the explanation is illustrative and the invention is limited only by the appended claims.

What is claimed is:

1. A method of forming a protective film on a magnetic head for recording and reading data in a magnetic recording medium, comprising the steps of:
forming a corrosion-resistant film on an entire surface of the magnetic head, and
forming a wear-resistant film on the corrosion-resistant film without exposing the corrosion-resistant film to atmosphere after forming the corrosion-resistant film, said wear-resistant film having a wear resistance greater than that of the corrosion-resistant film.

2. A method of forming a protective film according to claim 1, wherein said wear-resistant film is formed on the corrosion-resistant film by a method different from that forming the corrosion-resistant film on the recording medium.

3. A method of forming a protective film according to claim 2, wherein before forming the corrosion-resistant film, said method further comprises the steps of:
placing the magnetic head in a load lock chamber,
evacuating the load lock chamber,
transferring the magnetic head to a transfer chamber in a vacuum state, and
transferring the magnetic head to a corrosion-resistant film forming device in a vacuum state, in which the corrosion-resistant film is formed on the magnetic head, and
after forming the corrosion-resistant film, said method further comprises the steps of:
transferring the magnetic head back to the transfer chamber, and
transferring the magnetic head to a wear-resistant film forming device in a vacuum state, in which the rear-resistant film is formed on the corrosion-resistant film.

4. A method of forming a protective film according to claim 3, further comprising the steps of transferring the magnetic head to a cleaning device for cleaning the magnetic head, and transferring the magnetic head back to the transfer chamber, before the step of transferring the magnetic head to the corrosion-resistant film forming device.

5. A method of forming a protective film according to claim 4, further comprising the steps of transferring the magnetic head to a sputtering device, sputtering a Si film on the magnetic head, and transferring the magnetic head back to the transfer chamber, after cleaning the magnetic head and before forming the corrosion-resistant film.

6. A method of forming a protective film according to claim 5, wherein said corrosion-resistant film forming device is an electron cyclotron resonance chemical vapor deposition device, and said wear-resistant film forming device is a filtered cathodic vacuum arc device.

7. A method of forming a protective film according to claim 6, wherein said corrosion-resistant film is formed of a diamondlike carbon film, and said wear-resistant film is formed of a tetrahedral amorphous carbon film.

8. A method of forming a protective film according to claim 7, wherein said silicon film is formed under the diamondlike carbon film and between the diamondlike carbon film and the tetrahedral amorphous carbon film.

9. A method of forming a protective film according to claim 8, wherein said tetrahedral amorphous carbon film is formed partly above the diamondlike carbon film.
